(19) United States
(12) Patent Application Publication
(10) Pub. No.: US 2012/0204196 A1
(43) Pub. Date: Aug. 9, 2012

(54) DRIVE DEVICE FOR OPTICAL DISC APPARATUS

(75) Inventors: Daisuke TAKASAKA, Osaka (JP); Tetsuya Tamura, Osaka (JP); Masaki Nakatani, Osaka (JP); Katsuo Ichinohe, Osaka (JP); Rikiya Ueshima, Osaka (JP); Tomohiro Kobayashi, Osaka (JP); Yoshiyuki Nakagawa, Osaka (JP); Yasuhide Mizuta, Osaka (JP)

(73) Assignee: Funai Electric Co., Ltd.

(21) Appl. No.: 13/366,539

(22) Filed: Feb. 6, 2012

(30) Foreign Application Priority Data
Feb. 7, 2011 (JP) 2011-024481

(51) Int. Cl. G11B 17/05

(52) U.S. Cl. 720/604; G9B/17.013

(57) ABSTRACT

A drive device for an optical disc apparatus comprising: a lever arm for supporting a traverse chassis while allowing the traverse chassis to be raised and lowered; and a cam slider in cam engagement with the lever arm, the cam slider moving in a direction substantially orthogonal to a movement direction of the lever arm to cause the lever arm to move up and down; wherein the lever arm is provided with a boss projecting toward the cam slider, and a supported part supported by the cam slider in a chucked position of an optical disc; and wherein the cam slider is provided with a groove in engagement with the boss, and a support part for supporting the supported part in the chucked position of the optical disc.

This application is based on Japanese Patent Application No. 2011-024481 filed on Feb. 7, 2011, the contents of which are hereby incorporated by reference.

### BACKGROUND OF THE INVENTION

1. Field of the Invention

The present invention relates to a drive device for an optical disc apparatus for recording on or playing a CD, DVD, BD (Blu-ray Disc), or other optical disc.

2. Description of Related Art

Apparatuses designed so that a disc tray on which an optical disc is placed is moved in the apparatus body, the optical disc is clamped between a disc holder (clamper) and a turntable provided in the apparatus body, and the optical disc is recorded on or played are conventionally known as optical disc apparatuses. Various improvements to the disc-loading mechanisms of optical disc apparatuses have also been proposed in recent years.

There is disclosed in Japanese Laid-open Patent Publication No. 2007-18658 a disc apparatus having a chassis fixed to the device body; a traverse mechanism capable of being raised and lowered in a specified direction relative to the chassis via a plurality of gears by the driving of a motor; and a pickup unit provided with an optical pickup, disposed on the traverse mechanism, and designed to be moveable in a direction substantially orthogonal to the raising and lowering direction of the traverse mechanism by the driving of the motor;

the disc apparatus further comprising a cam slider provided to the chassis so as to be able to move in a direction substantially orthogonal to the raising and lowering direction of the traverse mechanism and the movement direction of the pickup unit, and a shift lever provided to the traverse mechanism so that the traverse mechanism is raised and lowered by cam engagement with the cam slider;

wherein the apparatus is further provided with a tray for conveying the disc, and a tray gear that comes into meshed engagement with the rack thereof and drives the tray; the tray on which the disc is placed is moved into the apparatus body; the disc is clamped between a clamper provided in the apparatus body and a turntable provided to the traverse mechanism; and the disc is recorded on or played by the optical pickup; and

wherein the apparatus is further provided with a rack member for moving the pickup unit by the driving of the motor; pressure is applied to the outer circumference of the tray gear by the distal end of the rack member to temporarily rotate the tray gear when the tray is opened, whereby the tray gear and the rack of the cam slider come into meshed engagement and the tray gear is interlocked with the driving of the motor to start rotation; the rack member is held while being drawn in by the cam slider when the cam slider is moved by the rotation of the tray gear; the rack member is held by the chassis instead of the cam slider when the traverse mechanism is lowered by the movement of the cam slider; the tray is pushed out by the cam slider after the traverse mechanism is completely lowered, and the tray gear and the rack part of the tray come into meshed engagement.

There is disclosed in Japanese Laid-open Patent Publication No. 2006-40393 a disc apparatus comprising:

a drive motor as a power source;

a disc tray provided so as to slide relative to a disc apparatus body and to be able to open and close, the disc tray provided with a tray rack capable of holding a disc and designed to receive an open/close driving power based on the driving power of the drive motor, and with a tray groove as an interlocking mechanism;

a tray-open switch for detecting that the disc tray is open;

an optical pickup unit for irradiating the disc with light, the optical pickup unit being able to reciprocate to and from the inner or outer circumference of the disc, being able to receive a reciprocating driving power based on the driving power of the drive motor, and being provided with an OPU rack on which a first boss is installed;

an inner-circumference attainment detection sensor for detecting that the optical pickup unit has reached the inner circumference of the disc;

a traverse assembly unit comprising a traverse holder designed to be raisable and lowerable and provided with a second boss for receiving a raising and lowering driving power based on the driving power of the drive motor, a lever trigger having a linking boss and a first groove in engagement with the first boss of the OPU rack to interlock with the movement of the OPU, and a gear group for transmitting the driving power of the drive motor; and

a loader chassis unit that is provided with a mounted drive motor, designed to receive transmission of the driving power of the drive motor via the gear group, adapted to pivot a gear tray provided with a transmission-preventing blocker, further provided with a cam slider rack in meshed engagement with the gear tray, further provided with a cam groove in engagement with the second boss of the traverse holder, with an upright boss in engagement with the tray groove of the disc tray, and with a linking groove in engagement with the linking boss of the lever trigger, and further provided with a cam slider designed to allow interlocking between the traverse holder and the disc tray, and interlocking with the movement of the lever trigger;

wherein the apparatus is further provided with an encoder sensor for detecting the rotational speed of the drive motor in forward and reverse rotary driving;

the OPU rack receives the driving power transmitted via the gear group on the basis of the rotational speed of the drive motor in the forward rotating direction as detected by the encoder sensor, whereby the optical pickup unit is moved toward the inner circumference of the disc;

the lever trigger having the first groove in engagement with the first boss is interlocked and moved by the first boss moved to the inner circumference by the movement of the OPU rack, the cam slider having the interlocking groove in engagement with the interlocking boss is interlocked and made to slide by the interlocking boss moved together with the movement of the lever trigger, the gear tray in meshed engagement with the slider rack receives the driving power via the gear group and rotates in correspondence with the sliding, the cam slider is further made to slide by the rotation of the gear tray, and the traverse assembly unit is lowered by the interlocked movement of the traverse holder having the second boss in engagement with the cam groove; and

the disc tray having the tray groove in engagement with the upright boss moves in interlocked fashion in the opening direction in correspondence with the sliding of the cam slider, the tray rack comes into meshed engagement with the gear tray, the driving power transmitted via the gear group is received, and the disc tray is opened to thereby release the tray-open switch.

There is disclosed in Japanese Laid-open Patent Publication No. 2004-246975 a disc playing apparatus comprising a turntable for supporting and rotating a disc, and a tray having a disc placed thereupon and bringing the disc close to and away from the turntable; wherein a disc holder for holding the mounted disc is provided to the tray, and the disc holder is moved in a direction away from the turntable when the disc is placed close to the turntable and is then supported by the turntable.

The aforementioned optical disc apparatuses are configured so that the cam slider is moved to the left and right via a plurality of gears by the driving of a motor, the lever arm in cam engagement with the cam slider moves up and down, and the traverse assembly for supporting the lever arm is caused to move up and down as well.

In this arrangement, the lever arm is moved up and down by the corresponding engagement of two bosses provided to the lever arm with two grooves provided in the cam slider. Accordingly, the lever arm and the front end part of the traverse assembly are supported by, and transfer their weight to, the two bosses, and the orientation of the traverse assembly is maintained. Because of this structure, a large impact is applied to the boss when the apparatus is dropped.

Accordingly, it is thought to be preferable for the size of the bosses to be increased to allow the bosses to endure a sufficient load, and for the bosses to be provided at a distance from each other to the left and right to allow the traverse assembly to be held in a stable orientation. However, with the recent demand for smaller and thinner optical disc apparatuses, there is a trend toward smaller components, and the cam slider is no exception. Reducing the size of the cam slider inevitably leads to using narrower bosses and bringing the bosses closer together. This creates a tendency for reducing the amount of load that the bosses can endure and preventing the orientation of the lever arm from being stably maintained. These problems cannot be solved by the aforementioned three cited techniques.

### SUMMARY OF THE INVENTION

An object of the present invention is to provide a drive device for an optical disc apparatus in which the orientation of the lever arm can remain stable and resistance to drop impact can be ensured even with a smaller cam slider.

In order to achieve the aforementioned object, the present invention provides a drive device for an optical disc apparatus comprising a lever arm for supporting a traverse chassis while allowing the traverse chassis to be raised and lowered; and a cam slider in cam engagement with the lever arm, the cam slider moving in a direction substantially orthogonal to a movement direction of the lever arm to cause the lever arm to move up and down; wherein the lever arm is provided with a boss projecting toward the cam slider, and a supported part supported by the cam slider in a chucked position of an optical disc; and wherein the cam slider is provided with a groove in engagement with the boss, and a support part for supporting the supported part in the chucked position of the optical disc.

In the drive device for an optical disc apparatus, the support part and the supported part may be provided in a plurality of sets.

In the drive device for an optical disc apparatus, the boss and the groove may be provided in a plurality of sets.

In the drive device for an optical disc apparatus, the boss and the groove are preferably provided in a single set, and the support part and the supported part are preferably provided in two sets.

In the drive device for an optical disc apparatus, the support part is preferably an upper surface part of a back end of the cam slider near the two lateral ends.

In the drive device for an optical disc apparatus, the boss is preferably loosely fitted in the groove in the chucked position of the optical disc.

The present invention makes it possible to provide a drive device for an optical disc apparatus in which the orientation of the lever arm and the traverse assembly in the chucked position of the optical disc can remain stable, there is no concern that the boss will undergo creep deformation, and resistance to drop impact can be ensured even with a smaller cam slider by providing the supported part and the support part in addition to ensuring engagement between the groove and the boss.

### BRIEF DESCRIPTION OF THE DRAWINGS

FIG. 1A is a plan view of a drive device for an optical disc apparatus according to the present invention;

FIG. 1B is a front view of the drive device for an optical disc apparatus according to the present invention;

FIG. 1C is a left-side view of the drive device for an optical disc apparatus according to the present invention;

FIG. 1D is a right-side view of the drive device for an optical disc apparatus according to the present invention;

FIG. 1E is a back view of the drive device for an optical disc apparatus according to the present invention;

FIG. 1F is a bottom view of the drive device for an optical disc apparatus according to the present invention;

FIG. 2A is a view of FIG. 1A, with the cover and disc tray removed;

FIG. 2B is a view of FIG. 1B, with the cover and disc tray removed;

FIG. 2C is a view of FIG. 1C, with the cover and disc tray removed;

FIG. 2D is a view of FIG. 1D, with the cover and disc tray removed;

FIG. 2E is a view of FIG. 1E, with the cover and disc tray removed;

FIG. 2F is a view of FIG. 1F, with the cover and disc tray removed;

FIG. 3A is a plan view of the traverse assembly and the lever arm according to the present invention;

FIG. 3B is a front view of the traverse assembly and the lever arm according to the present invention;

FIG. 3C is a left-side view of the traverse assembly and the lever arm according to the present invention;

FIG. 3D is a right-side view of the traverse assembly and the lever arm according to the present invention;

FIG. 3E is a back view of the traverse assembly and the lever arm according to the present invention;

FIG. 3F is a bottom view of the traverse assembly and the lever arm according to the present invention;

FIG. 4A is a plan view of the traverse assembly according to the present invention;

FIG. 4B is a front view of the traverse assembly according to the present invention;

FIG. 4C is a left-side view of the traverse assembly according to the present invention;

FIG. 4D is a right-side view of the traverse assembly according to the present invention;

FIG. 4E is a back view of the traverse assembly according to the present invention;

FIG. 4F is a bottom view of the traverse assembly according to the present invention;

FIG. 5A is a plan view of the lever arm according to the present invention;

FIG. 5B is a front view of the lever arm according to the present invention;

FIG. 5C is a left-side view of the lever arm according to the present invention;

FIG. 5D is a right-side view of the lever arm according to the present invention;

FIG. 5E is a back view of the lever arm according to the present invention;

FIG. 5F is a bottom view of the lever arm according to the present invention;

FIG. 6A is a plan view of a cam slider according to the present invention;

FIG. 6B is a front view of a cam slider according to the present invention;

FIG. 6C is a left-side view of a cam slider according to the present invention;

FIG. 6D is a right-side view of a cam slider according to the present invention;

FIG. 6E is a back view of a cam slider according to the present invention;

FIG. 6F is a bottom view of a cam slider according to the present invention;

FIG. 7A is a plan view showing the assembled state of a lever arm and a cam slider in the un-chucked position of an optical disc according to the present invention;

FIG. 7B is a front view showing the assembled state of a lever arm and a cam slider in the un-chucked position of an optical disc according to the present invention;

FIG. 7C is a left-side view showing the assembled state of a lever arm and a cam slider in the un-chucked position of an optical disc according to the present invention;

FIG. 7D is a right-side view showing the assembled state of a lever arm and a cam slider in the un-chucked position of an optical disc according to the present invention;

FIG. 8A is a plan view showing the assembled state of a lever arm and a cam slider in the chucked position of an optical disc according to the present invention;

FIG. 8B is a front view showing the assembled state of a lever arm and a cam slider in the chucked position of an optical disc according to the present invention;

FIG. 8C is a left-side view showing the assembled state of a lever arm and a cam slider in the chucked position of an optical disc according to the present invention; and

FIG. 8D is a right-side view showing the assembled state of a lever arm and a cam slider in the chucked position of an optical disc according to the present invention.

### DETAILED DESCRIPTION OF PREFERRED EMBODIMENTS

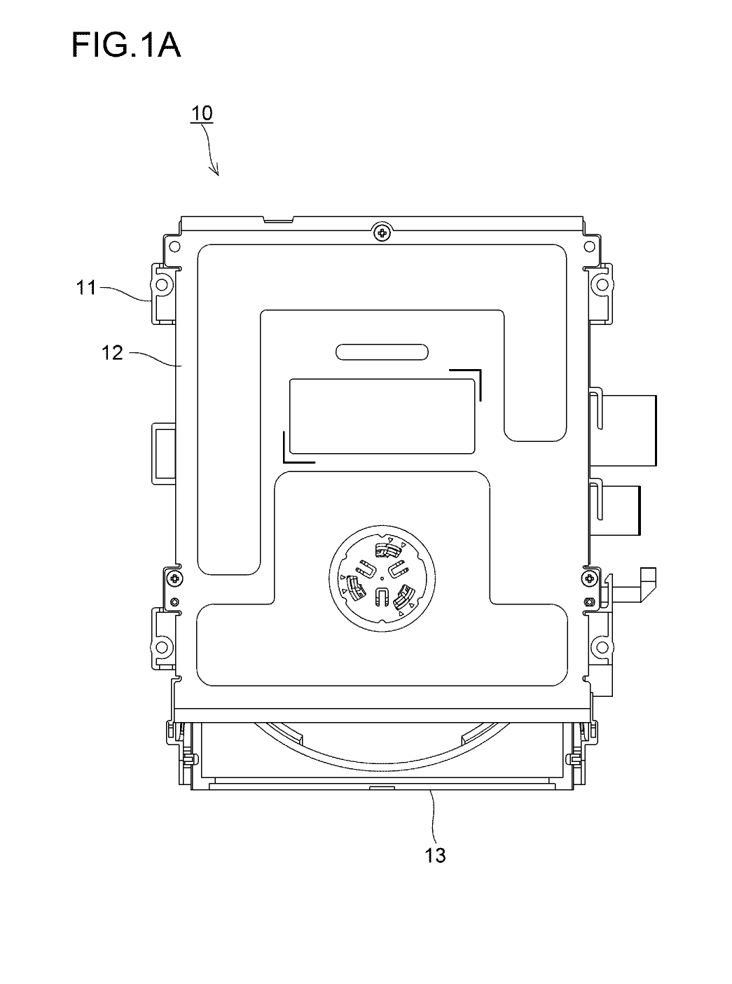

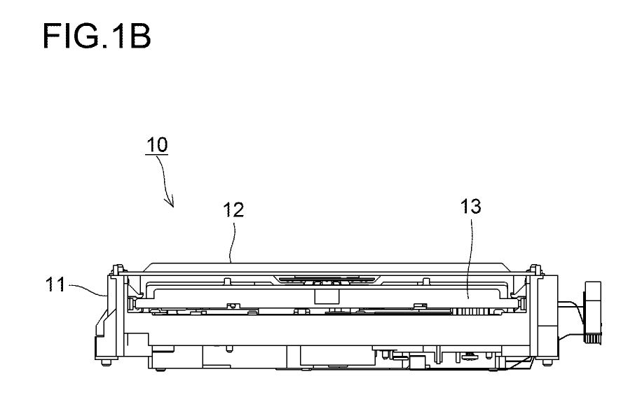

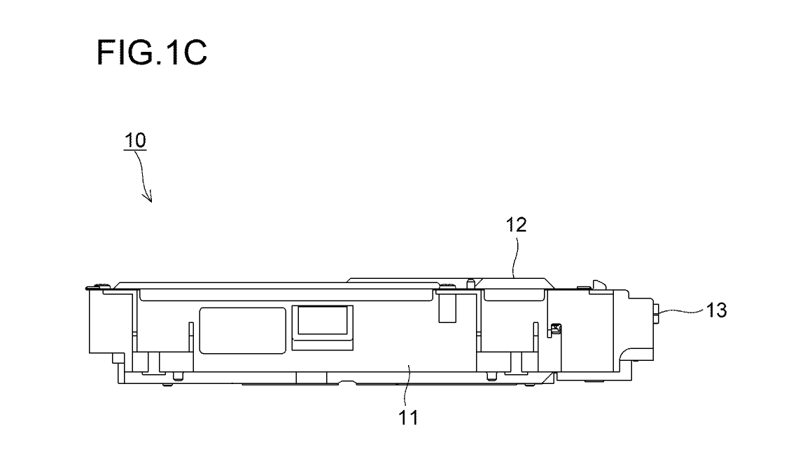

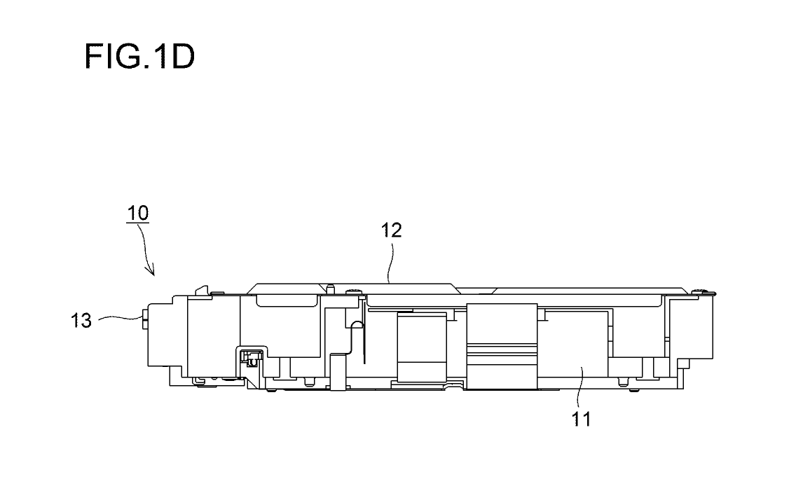

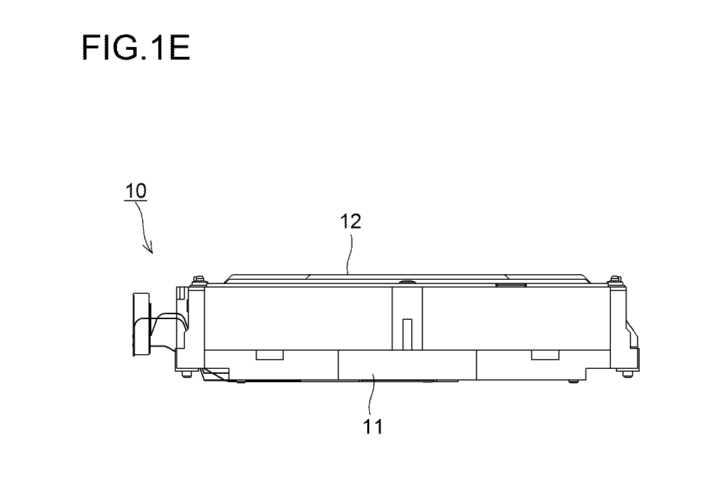

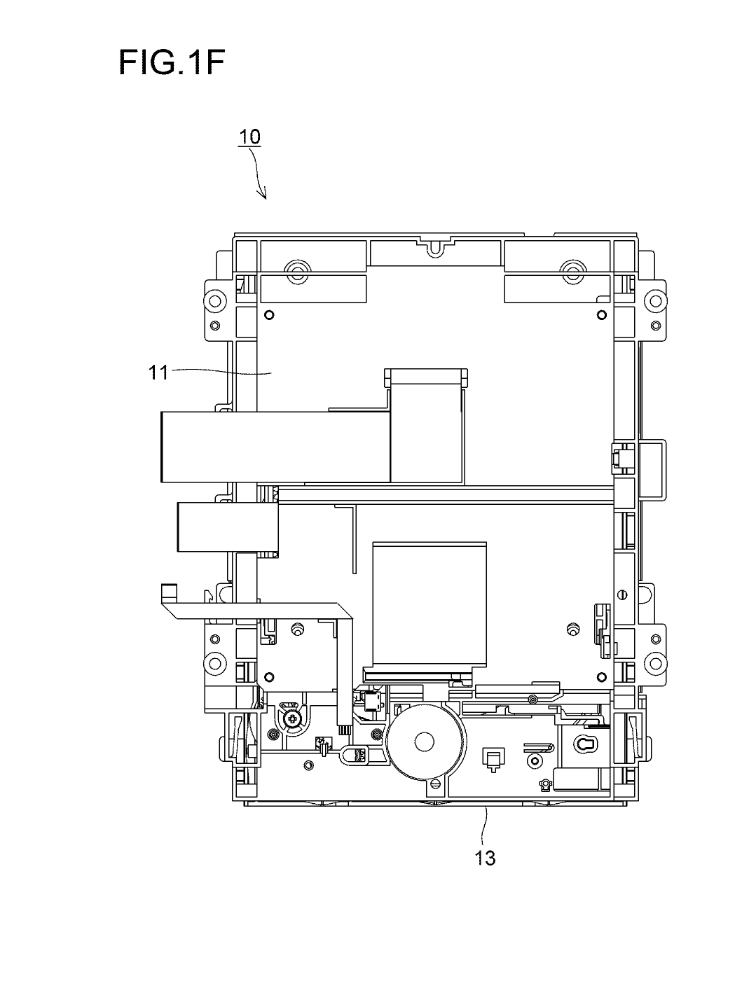

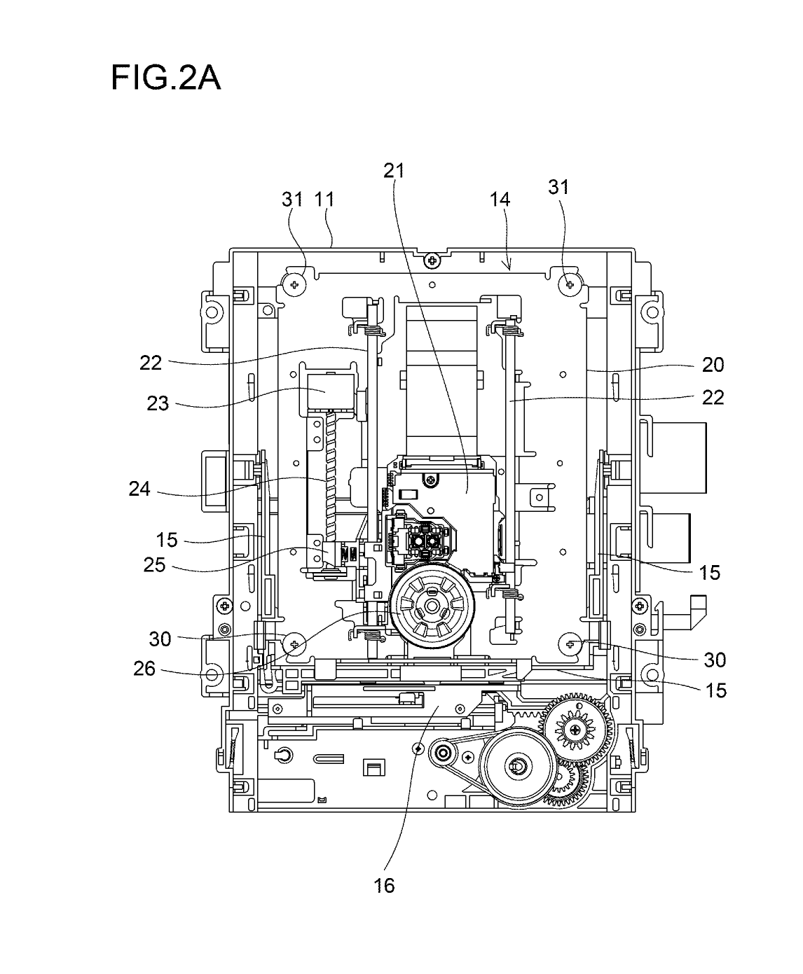

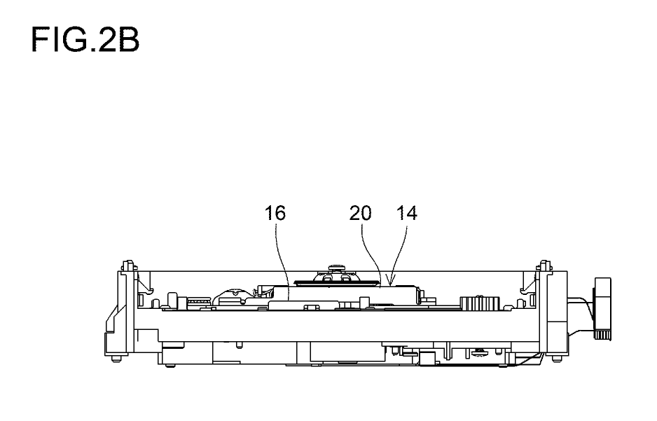

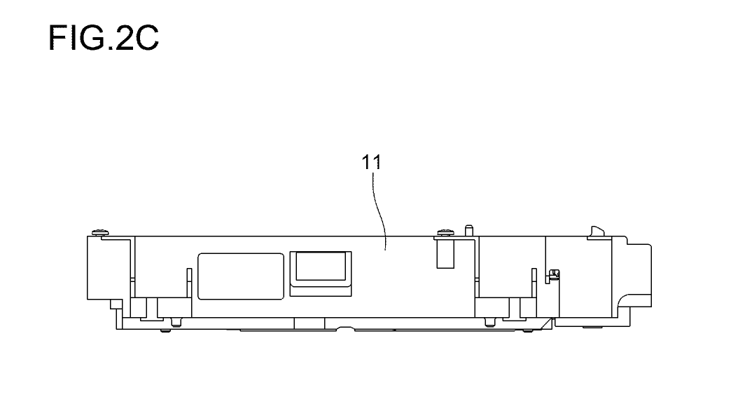

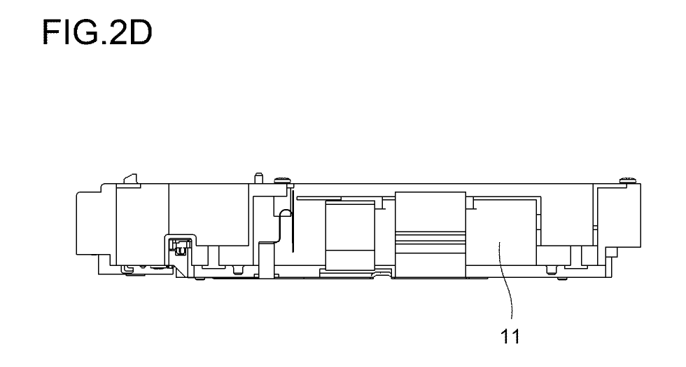

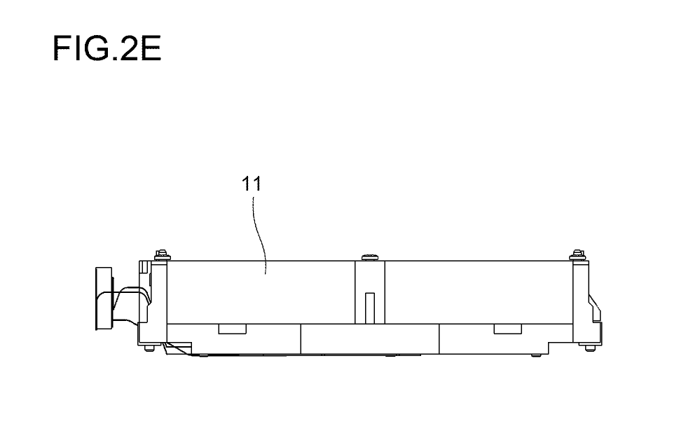

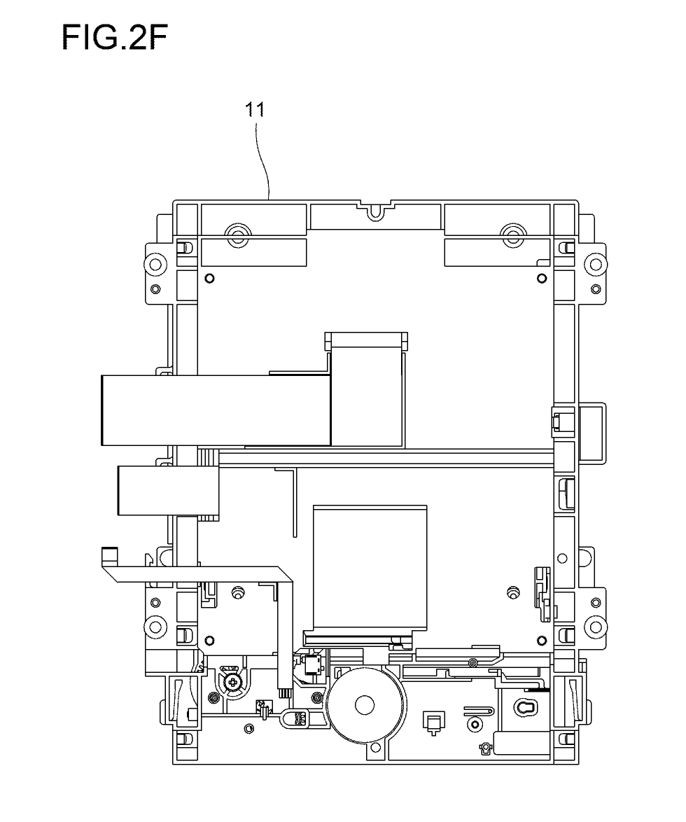

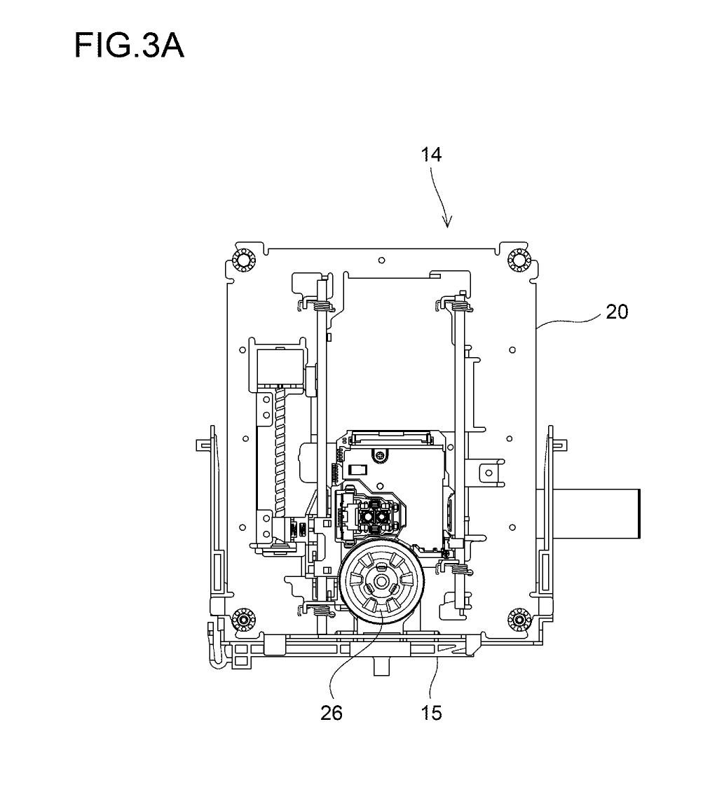

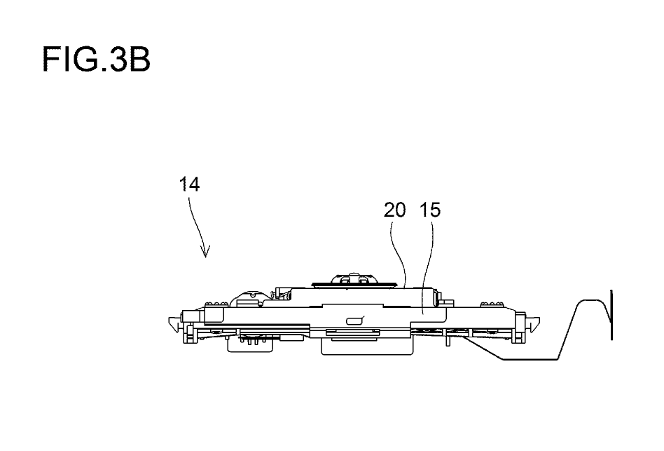

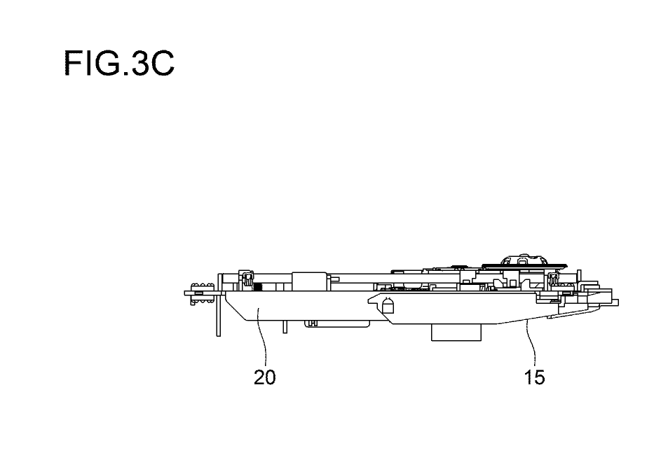

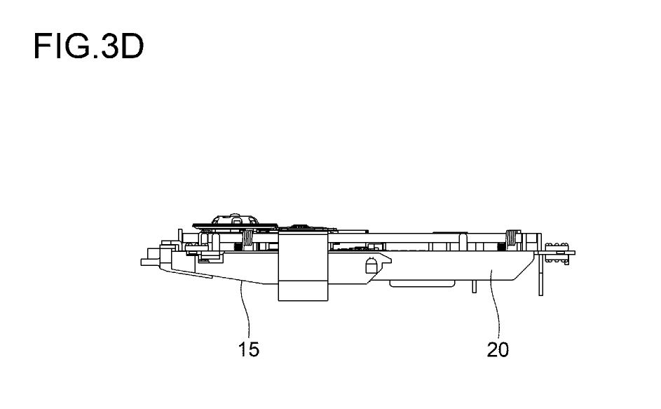

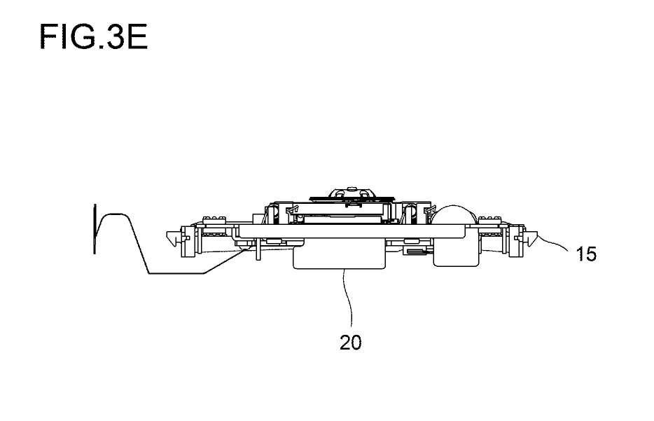

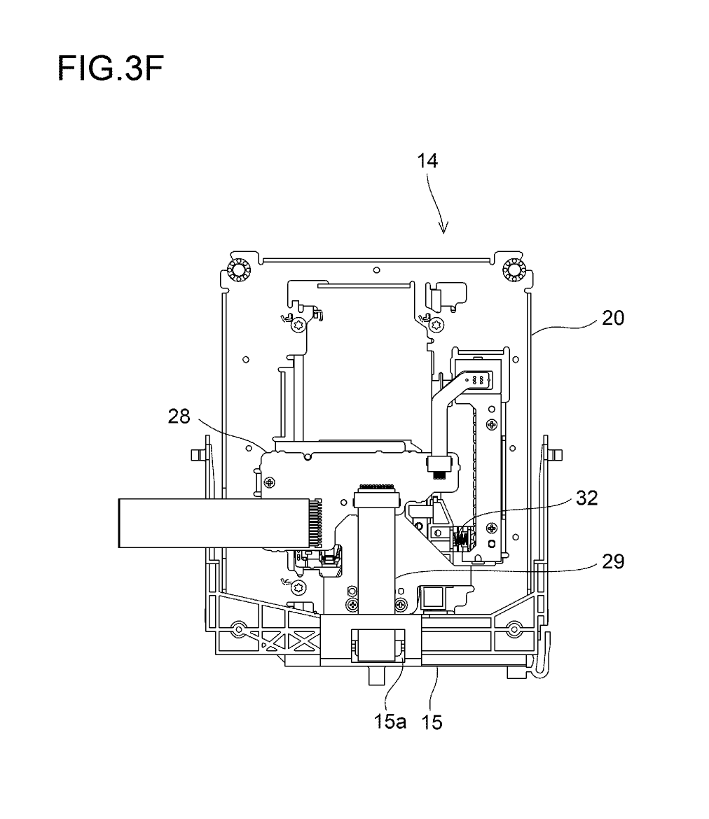

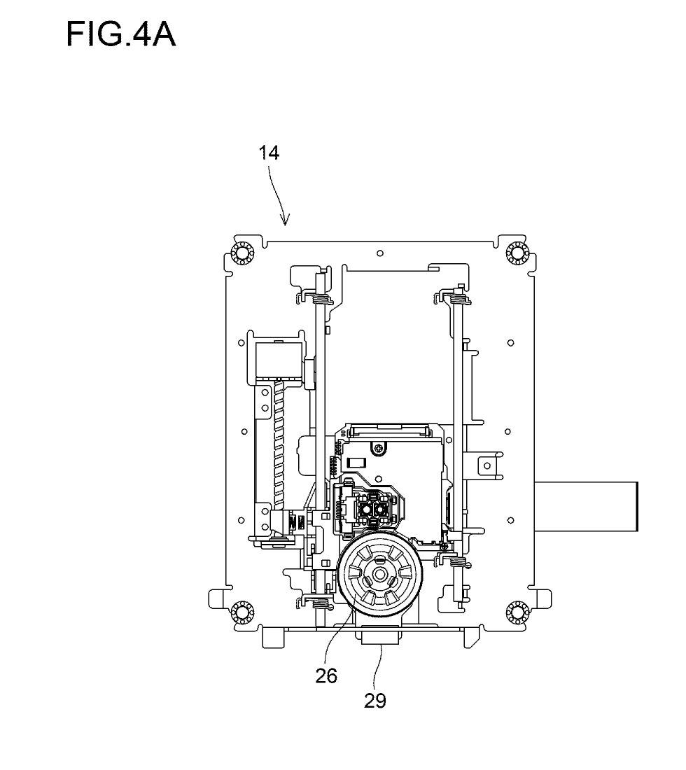

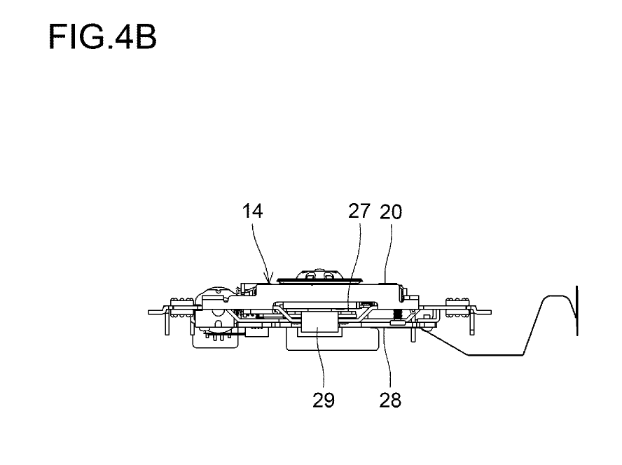

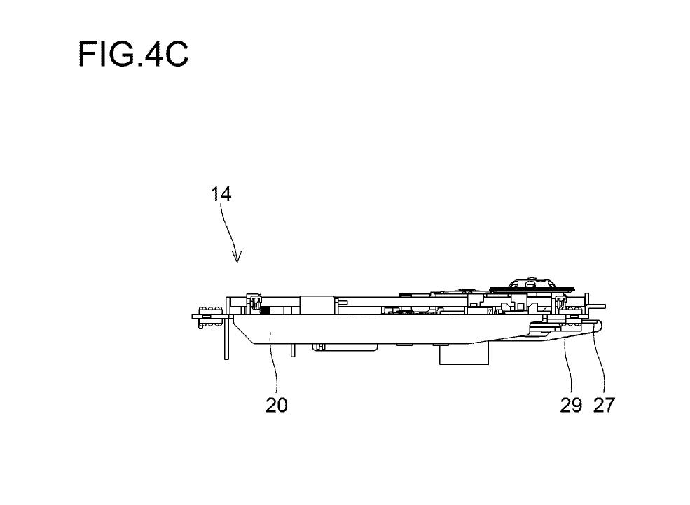

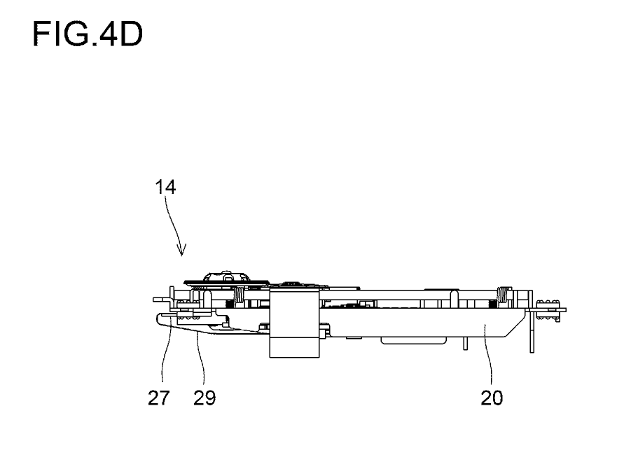

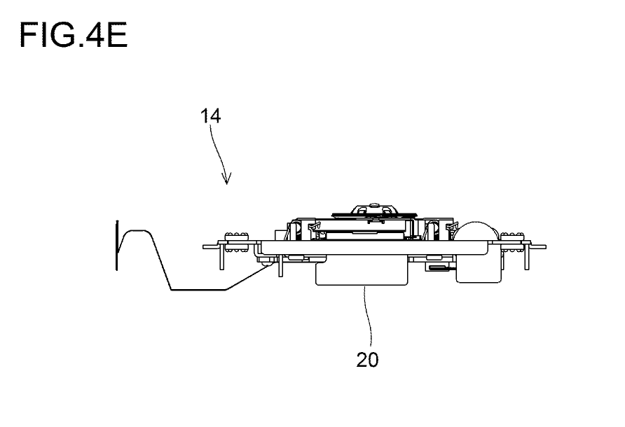

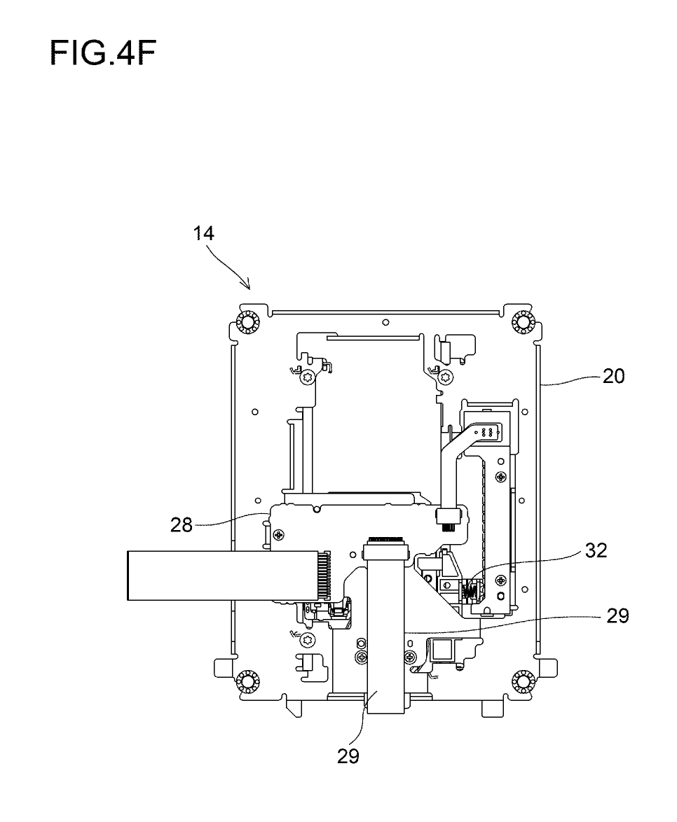

FIGS. 1A to 1F are six views of a drive device for an optical disc apparatus according to the present invention, where FIG. 1A is a plan view, FIG. 1B is a front view, FIG. 1C is a left-side view, FIG. 1D is a right-side view, FIG. 1E is a back view, and FIG. 1F is a bottom view. FIGS. 2A to 2F are views of FIGS. 1A to 1F, respectively, with the upper cover and disc tray removed. In addition, FIGS. 3A to 3F are six views of the traverse assembly 14 and the lever arm 15, where FIG. 3A is a plan view, FIG. 3B is a front view, FIG. 3C is a left-side view, FIG. 3D is a right-side view, FIG. 3E is a back view, and FIG. 3F is a bottom view. FIGS. 4A to 4F are six views of the traverse assembly 14, where FIG. 4A is a plan view, FIG. 4B is a front view, FIG. 4C is a left-side view, FIG. 4D is a right-side view, FIG. 4E is a back view, and FIG. 4F is a bottom view.

A drive device 10 is accommodated in the housing of an apparatus body that forms the exterior of an optical disc apparatus. The drive device 10 comprises a loader chassis 11 for accommodating the members of the drive device 10, a cover 12 for covering the upper-surface opening of the loader chassis 11, a disc tray 13 for conveying an optical disc, a traverse assembly 14 capable of rotating and moving up and down in a direction substantially perpendicular (vertical direction) to the conveying direction (forward/backward direction) of the disc tray 13, a vertically moving lever arm 15 having a substantially U-shape in plan view and covering part (near the front end of the lower surface in the present embodiment) of the lower surface of the traverse assembly 14 as well as supporting the traverse assembly 14, a cam slider 16 for engaging as a cam with the front part of the lever arm 15 and moving in a left-right direction (direction substantially orthogonal to the conveying direction of the disc tray 13 and the up/downwardly moving direction of the traverse assembly 14) to vertically move the lever arm 15, and a motor (not shown) for driving the disc tray 13 and the cam slider 16 via a plurality of gears.

The traverse assembly 14 comprises a traverse chassis 20 for mounting the members; an optical pickup unit (OPU) 21; two guide shafts 22, 22 for supporting the OPU 21 while allowing movement in the radial direction (forward/backward direction) of the optical disc; a stepper motor 23 for driving the OPU 21; a lead screw 24 connected to the stepper motor 23; a resin tooth 25 fixed to the OPU 21, the tooth extending toward the lead screw 24 in a cantilevered state, the meshing cogs thereof being in meshed engagement with the lead screw 24, and the tooth being advanced following the rotation of the lead screw 24; a tooth spring 32 for urging the meshing cogs in the direction of meshing with the lead screw 24 (refer to FIG. 3F); a spindle motor 26 provided to the section near the front of the upper surface of the traverse chassis 20 and used for rotating the optical disc; a spindle motor PCB (printed board) 27 on which the spindle motor 26 is mounted (refer to FIG. 4B); a PCB 28 provided to the lower surface of the traverse chassis 20 and used for controlling the entire drive device 10 (refer to FIG. 4F); and a spindle motor FFC (flexible flat cable) 29 connected by one end to the spindle motor PCB 27, extended from the front of the traverse chassis 20 around the underside of the traverse chassis 20, passed between the traverse chassis 20 and the lever arm 15, and connected by the other end to the PCB 28 (refer to FIG. 4A).

The traverse assembly 14 is locked to the lever arm 15 by locking parts 30, 30 at two points on the front end of the traverse chassis 20, and is locked to the loader chassis 11 by locking parts 31, 31 at two points on the back end of the traverse chassis 20. The locking parts 30, 31 are rubber O-rings and screws.

In the optical disc apparatus configured as described above, the disc tray 13 is conveyed in the disc device 10 by the driving of the motor when an optical disc is placed on the disc tray 13 in a pulled-out state. When the disc tray 13 is disposed at a specified position, transmission of the driving power of the motor to the disc tray 13 is canceled to stop the disc tray 13, the cam slider 16 is moved by the driving of the motor, and the traverse assembly 14 is raised. The traverse assembly 14 is thereby engaged with the optical disc, and the optical disc is chucked.

Transmission of the driving power of the motor to the cam slider 16 is cancelled and the cam slider 16 and the traverse assembly 14 are stopped when the optical disc is chucked. The OPU 21 is then moved to a specified position by the driving of the stepper motor 23, and the optical disc is recorded on or played. In addition, an operation opposite to that described above is performed when the optical disc is removed.

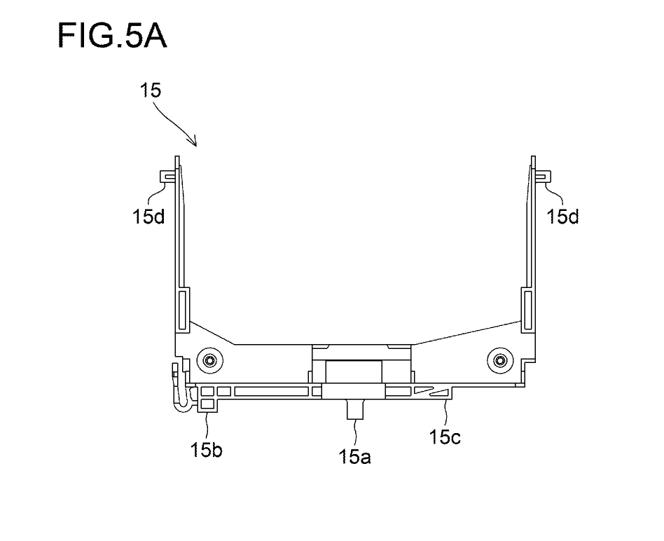

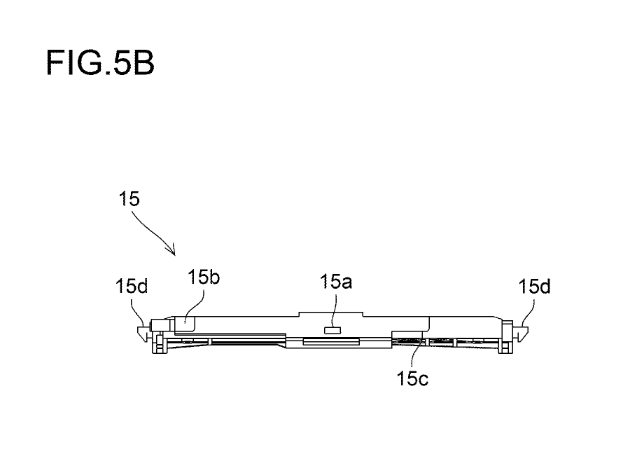

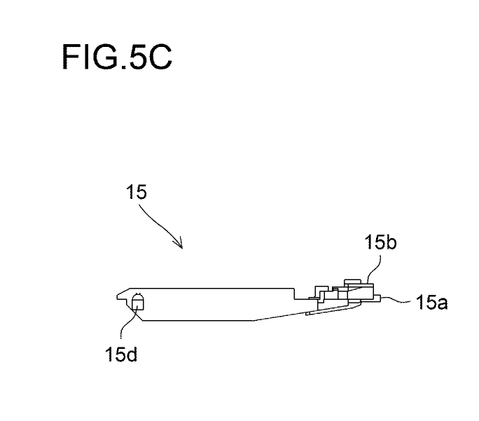

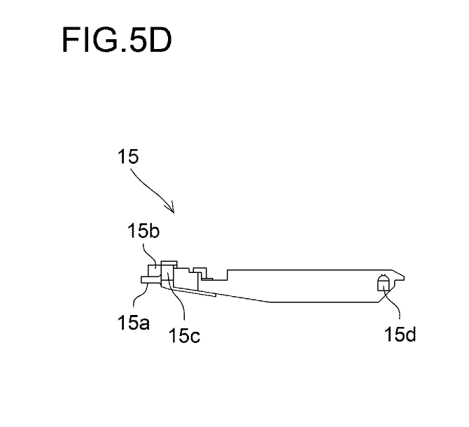

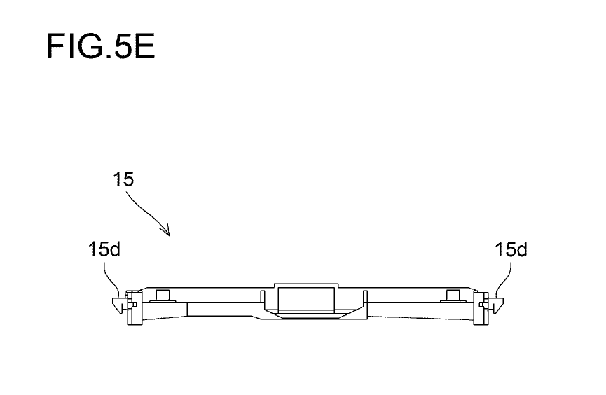

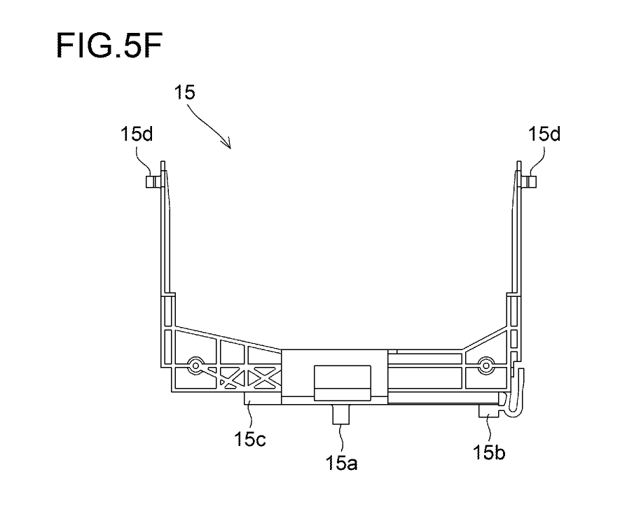

The structure of the lever arm 15 will now be described in detail. FIGS. 5A to 5F are six views of the lever arm 15, where FIG. 5A is a plan view, FIG. 5B is a front view, FIG. 5C is a left-side view, FIG. 5D is a right-side view, FIG. 5E is a back view, and FIG. 5F is a bottom view.

The lever arm 15 is formed of POM (polyoxymethylene) or the like by injection molding or the like, and comprises a boss 15a projecting toward a cam slider 16 (toward the front surface); supported parts 15b, 15c supported by the cam slider 16 in the chucked position of an optical disc; and axles 15d, 15d in the form of shafts that rotate in engagement with the loader chassis 11.

The boss 15a is a tabular projection formed in approximately the center section of the front surface of the lever arm, and should be of a length to pass through a below-described groove 16a.

The supported part 15b is a substantially cuboid section projecting frontward from the front end of the lever arm 15 near the left end. The bottom surface thereof is a planar surface designed to slide against and be supported by the upper surface of a below-described support part 16b. In addition, the section at which the bottom surface and the right-side surface thereof intersect each other is designed as a curved surface so as to prevent the below-described support part 16b from being caught when the part slides against the surface.

The other supported part, 15c, is a section on the front end of the lever arm 15 near the right end. The bottom surface thereof is a planar surface designed to slide against and be supported by the upper surface of a below-described support part 16c. In addition, the section at which the bottom surface and the right-side surface thereof intersect each other is designed as a curved surface so as to prevent the below-described support part 16c from being caught when the part slides against the surface.

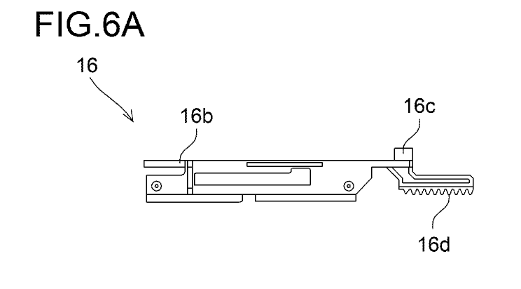

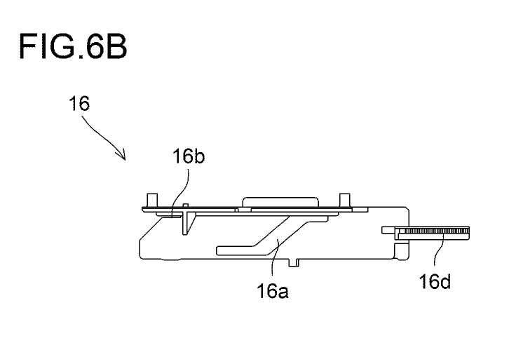

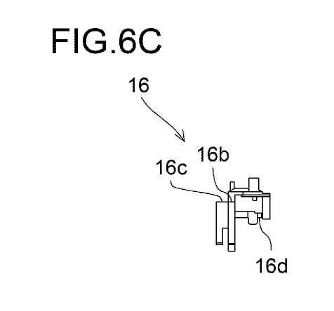

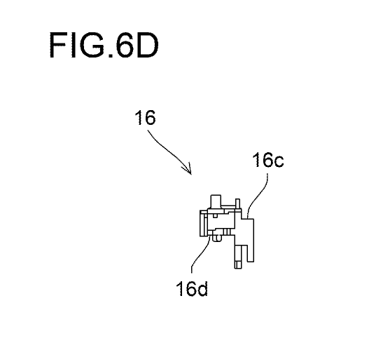

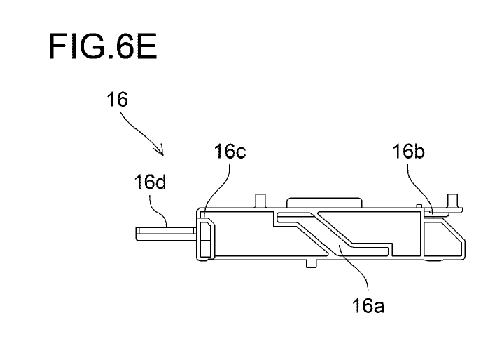

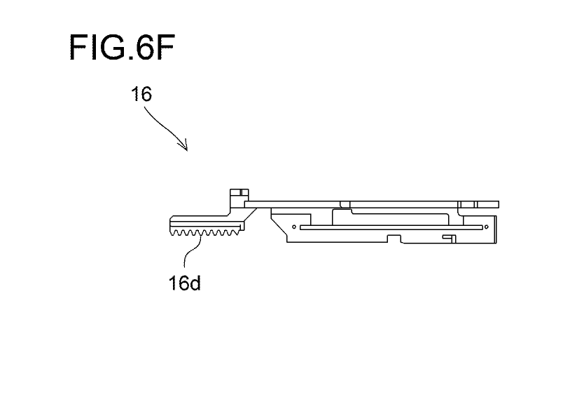

The structure of the cam slider 16 will now be described in detail. FIGS. 6A to 6F are six views of the cam slider 16, where FIG. 6A is a plan view, FIG. 6B is a front view, FIG. 6C is a left-side view, FIG. 6D is a right-side view, FIG. 6E is a back view, and FIG. 6F is a bottom view.

The cam slider 16 is formed of POM or the like by injection molding or the like, and comprises a groove 16a in engagement with the boss 15a; support parts 16b, 16c positioned on the upper surface part of the back end of the cam slider 16 near the two lateral ends and adapted to support the supported parts 15b, 15c in the chucked position of an optical disc; and a rack part 16d that is in meshed engagement with gears for transmitting the driving power of the motor.

The groove 16a is slit in the form of a through-hole for guiding the boss 15a. The groove 16a comprises a horizontally extending lower level, a middle level slanting from one end of the lower level in an upward slant, and an upper level extending horizontally from one end of the middle level.

The support part 16b is a section of the back end of the cam slider 16 near the left end. The upper surface thereof is a planar surface designed to slide against and support the bottom surface of the supported part 15b. In addition, the section leftward from the upper surface is designed as a slanted surface so as to prevent the supported part 15b from catching when the part slides against the surface.

The other support part, 16c, is a substantially cuboid section projecting backward from the back end of the cam slider 16 near the right end. The upper surface thereof is a planar surface designed to slide against and support the bottom surface of the supported part 15c. In addition, the section at which the upper surface and the left-side surface thereof intersect each other is designed as a slanted surface so as to prevent the supported part 15c from catching when the part slides against the surface.

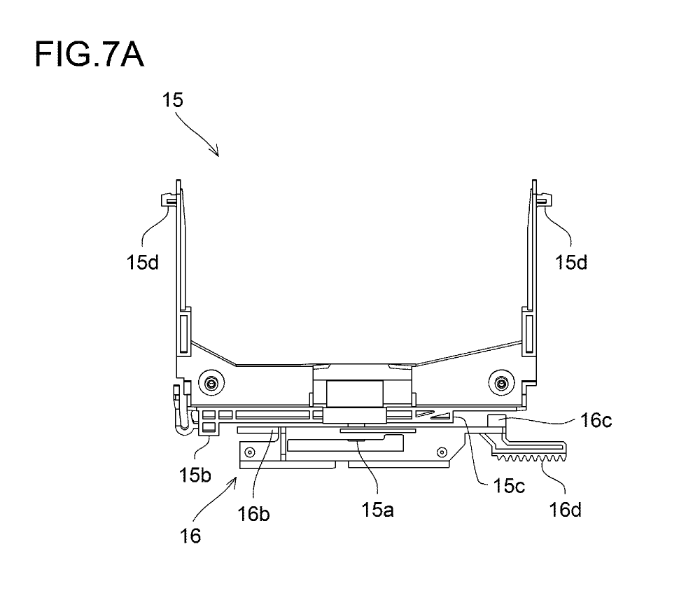

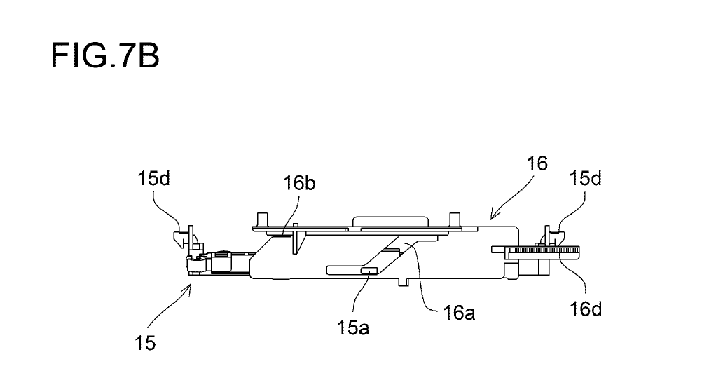

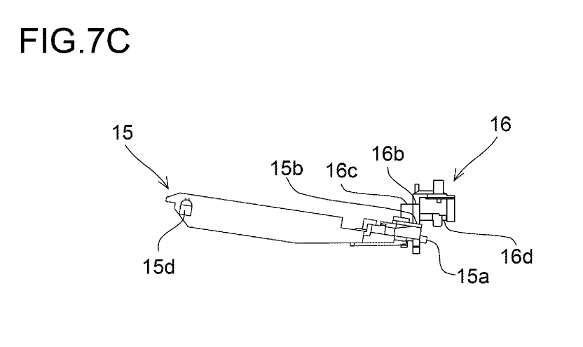

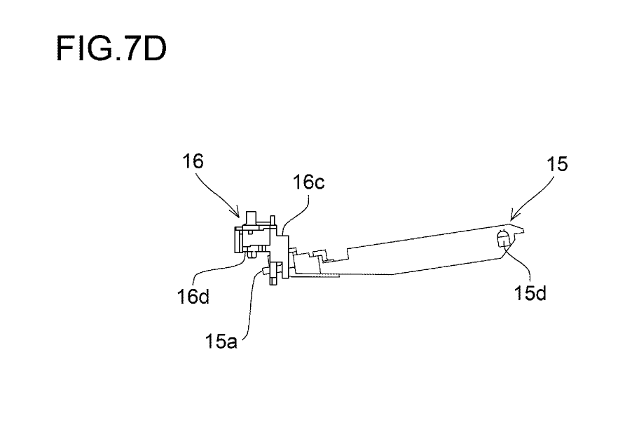

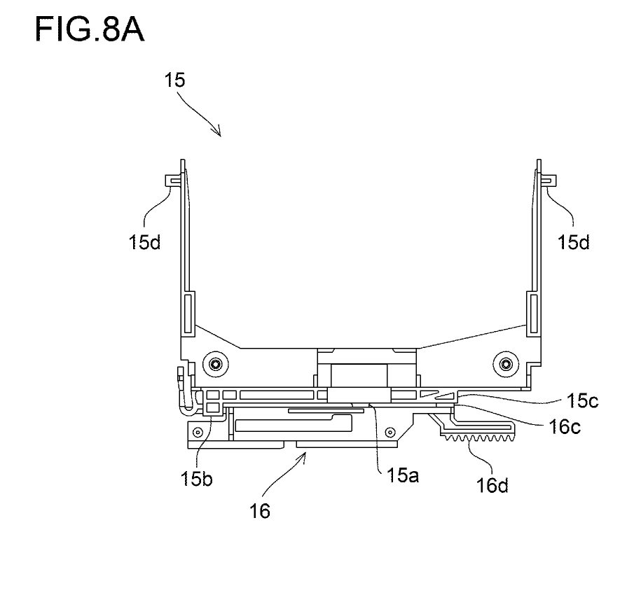

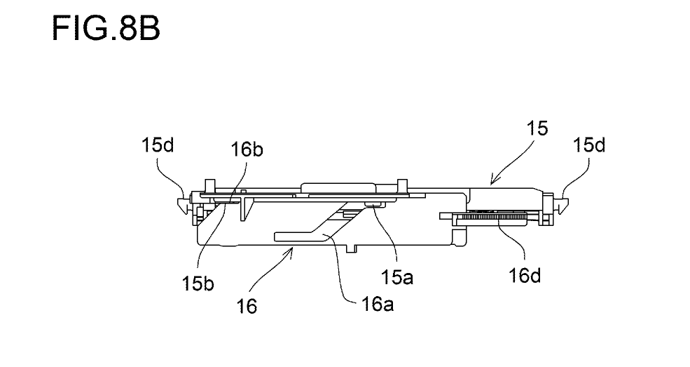

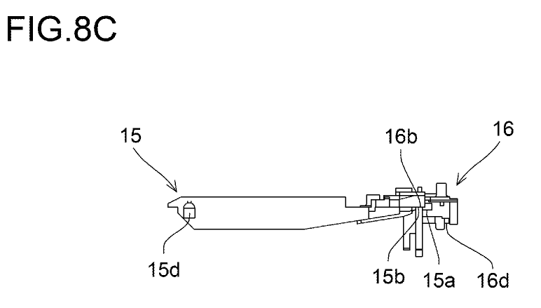

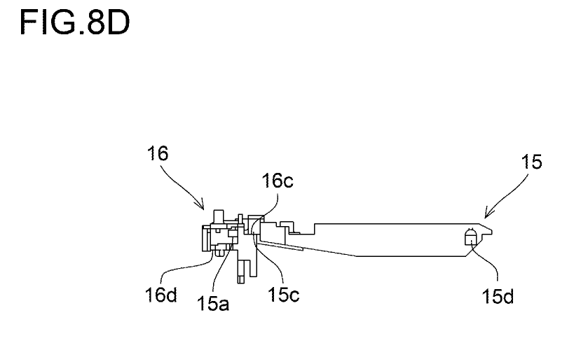

FIGS. 7A to 7D are four views showing the assembled state of the lever arm 15 and the cam slider 16 in the un-chucked position of an optical disc, where FIG. 7A is a plan view, FIG. 7B is a front view, FIG. 7C is a left-side view, and FIG. 7D is a right-side view. Also, FIGS. 8A to 8D are four views showing the assembled state of the lever arm 15 and the cam slider 16 in the chucked position of an optical disc, where FIG. 8A is a plan view, FIG. 8B is a front view, FIG. 8C is a left-side view, and FIG. 8D is a right-side view.

In the un-chucked position of an optical disc, that is, when the disc tray 13 is pulled out, the cam slider 16 is positioned on the right end and the boss 15a is positioned in the lower level of the groove 16a, resulting in a state in which the lever arm 15 is lowered. When an instruction is given to pull the disc tray 13 in from this state, the boss 15a is guided to the upper level through the middle level of the groove 16a by the movement of the cam slider 16 in the leftward direction, and the lever arm 15 is raised. In the chucked position of an optical disc, that is, when the disc tray 13 is stored, the cam slider 16 is positioned on the left end and the boss 15a is positioned in the upper level of the groove 16a, resulting in a state in which the lever arm 15 is raised.

In the chucked position of an optical disc, the boss 15a is loosely fitted in the groove 16a. Accordingly, the weight of the traverse assembly 14 and the lever arm 15 is applied in this state to the two points of the supported parts 15b, 15c and the support parts 16b, 16c without being applied to the boss 15a. The orientation of the traverse assembly in the chucked position of an optical disc is also maintained by the two points. Positioning these two points near the two lateral ends of the cam slider 16 and sufficiently separating the points from each other in the left-right direction of the lever arm 15 allows the traverse assembly to be maintained in a stable orientation even with a smaller cam slider 16.

The optical disc is set to the chucked position when shipped from the factory, and a load is therefore applied to two bosses in conventional products. This creates concern that the bosses will undergo creep deformation at the temperature (about 60°) in the shipping container. On the other hand, there is no concern that the bosses will undergo creep deformation because no load is applied to the boss 15a in the chucked position of an optical disc in the aforementioned embodiment, and there is no concern that creep deformation will occur because the load-bearing support parts 16b, 16c can be formed as sturdy parts. In addition, the impact from dropping the optical disc apparatus can be adequately absorbed by the support parts 16b, 16c because the drop impact is transmitted to the support parts 16b, 16c, allowing the apparatus to endure the drop impact.

The aforementioned embodiment describes a case in which there is one set of a boss and a groove, and there are two sets of support parts and supported parts, but there may be one or more sets of bosses and grooves, and one or more sets of support parts and supported parts.

However, maintaining the orientation of the lever arm using only a single point in one set of a support part and a supported part results in instability in a case in which there is one set of a boss and a groove, and one set of a support part and a supported part. It is therefore preferable that the boss be supported by the groove and the lever arm be held at two points. In this case, the load applied to the boss is reduced and there is no concern that the boss will undergo creep deformation because the load is applied to a support part other than the boss, and there is no concern that creep deformation will occur because the support part can be formed as a sturdy part.

When the apparatus has a configuration in which the lever arm is received at three or more points on the cam slider in the chucked position of an optical disc, maintaining the orientation tends to become unstable because it is difficult to accurately receive the lever arm at the same height. The apparatus thus preferably has a configuration in which the lever arm is received at two points.

The orientation of the lever arm 15 and the traverse assembly 14 in the chucked position of an optical disc can thus remain stable, there is no concern that the boss 15a will undergo creep deformation, and resistance to drop impact can be ensured even with a smaller cam slider 16 by providing the supported parts 15b, 15c and the support parts 16b, 16c in addition to ensuring engagement between the groove 16a and the boss 15a.

The present invention can be used for an optical disc apparatus for recording on and playing a CD, DVD, BD, or the like. Examples include BD/DVD players, BD/DVD recorders, BD/DVD recorders integrated with a TV, personal computers provided with a BD/DVD recorder/player, and the like.

What is claimed is:

1. A drive device for an optical disc apparatus, comprising:
a lever arm for supporting a traverse chassis while allowing the traverse chassis to be raised and lowered; and
a cam slider in cam engagement with the lever arm, the cam slider moving in a direction substantially orthogonal to a movement direction of the lever arm to cause the lever arm to move up and down;
wherein the lever arm is provided with a boss projecting toward the cam slider, and a supported part supported by the cam slider in a chucked position of an optical disc; and
wherein the cam slider is provided with a groove in engagement with the boss, and a support part for supporting the supported part in the chucked position of the optical disc.

2. The drive device for an optical disc apparatus according to claim 1, wherein the support part and the supported part are provided in a plurality of sets.

3. The drive device for an optical disc apparatus according to claim 1, wherein the boss and the groove are provided in a plurality of sets.

4. The drive device for an optical disc apparatus according to claim 1, wherein the boss and the groove are provided in a single set, and the support part and the supported part are provided in two sets.

5. The drive device for an optical disc apparatus according to claim 4, wherein the support part is an upper surface part of a back end of the cam slider near the two lateral ends.

6. The drive device for an optical disc apparatus according to claim 1, wherein the boss is loosely fitted in the groove in the chucked position of the optical disc.
